(19) United States
(12) Patent Application Publication
(10) Pub. No.: US 2013/0060633 A1
(43) Pub. Date: Mar. 7, 2013

(54) PRIVACY-ENHANCED INTERNET ADVERTISING SYSTEM

(71) Applicant: Nicholas St-Pierre, Toronto (CA)

(72) Inventor: Nicholas St-Pierre, Toronto (CA)

(21) Appl. No.: 13/223,895

(22) Filed: Sep. 1, 2011

(51) Int. Cl. G06Q 30/02

(52) U.S. Cl. 705/14.58; 705/14.49

(57) ABSTRACT

The present invention is a system and method for managing the IP address space allocation of an ISP to reduce the probability that a subscriber's physical location can be discovered based on its IP address. In particular, the present invention is a system and method operable to detect and manage the IP address space allocation of an ISP that is taking part in an advertising system over a communications medium. The system and method of the present invention may incorporate or otherwise be operable to achieve any of the following: isolating individual member IP address statistics as part of an advertising system; finding individual and logical target groups that achieve a level of demand and popularity among the advertising system; and implementing embodiments of mechanisms to dynamically modify the IP address allocation of one or a plurality of such members within the ISP address allocation system.

This application claims the benefit of U.S. Provisional Patent Application Ser. No. 61/379,119 filed Sep. 1, 2010.

### FIELD OF THE INVENTION

This invention relates in general to the field of systems and methods for advertising and more particularly to systems and methods for providing advertisements over a computer network.

### BACKGROUND OF THE INVENTION

Advertisements are delivered in a wide variety of forms and media. On computer networks such as the Internet, and on the World-Wide Web (web) in particular, advertisements are generally embedded within web pages. Such web advertisements appear in and incorporate many forms and formats, including text, audio, images, video and interactive applications. In some instances, the advertisements may be statically embedded within web pages, meaning that they are hard-coded within the markup code of the web page. Alternatively, advertisements may be dynamically or programmatically embedded within web pages.

In the case of dynamically embedded web advertisements, the web server supplying the web page may choose a web advertisement from among a number of web advertisements available for embedding. This choice may be made in accordance with an algorithm. In some instances the algorithm may be a simple rotation algorithm, whereby the web server progressively iterates through the list of web advertisements upon each request for a web page. Alternatively, the algorithm may simply provide for a pseudo-random selection. Additionally, more sophisticated algorithms select advertisements based on information known about the requesting client. For example, metadata supplied by a web browser client in the Hypertext Transfer Protocol (HTTP) request header may include such information relating to the requesting client as Internet Protocol (IP) address, web browser version, preferred language, etc.

IP addresses generally identify devices, such as client computers and web servers, connected to a computer network such as the Internet. IP addresses are allocated to network service providers and other parties by the Internet Assigned Numbers Authority (IANA). When an Internet subscriber accesses a service through an Internet Service Provider (hereinafter ISP) the internet enabled device that is used is typically assigned an IP address so as to allow the device on the worldwide Internet network. Such addresses are typically managed by the Service Provider and are assigned in either a static or dynamic fashion. A statically assigned IP address is always the same one used by a device given its authentication or identity credentials, whereas a dynamically assigned IP address is unique to an internet enabled device. A dynamically assigned IP address will be assigned to different users and devices based on an allocation strategy or algorithm devised by an IP address management standard subscribed to by the ISP.

Typically, in a broadband subscriber installation two predominant IP allocation systems exist. In the Cable MSO environment with bridged access IP addresses are allocated to both the Customer Premise Equipment (herein referred to as CPE) (e.g., PC, Home Router, etc) and to the broadband cable modem using the standards based Dynamic Host Configuration Protocol (DHCP), this method is also present in the RFC 1483 bridged environments found in DSL and fiber. Under DHCP environments, a subscriber's IP address is negotiated through a set of standards based interaction and the ISP assigns the end user device one or multiple IP addresses from an assigned, and usually contiguous, IP address block or pool.

In other environments, such as DSL and FTTH (Fiber to the Home), the IP address allocation is part of the PPPoE (PPP over Ethernet) and PPPoA (PPP over ATM) encapsulation sessions based on RFC 1661. More precisely, the Link Control Protocol (LCP) phase of the PPP sessions and the Internet Protocol Control Protocol (IPCP) negotiation portion of LCP handles the IP address allocation, like DHCP. IPCP typically assigns an IP address to end user equipment from a contiguous block of IP addresses commonly referred to as the IP Pool.

In real world Internet broadband service implementations, the main differentiation in the implementation of both protocols has been DHCP's inherent IP address stickiness to an end user device. Such stickiness is generally due to the protocol's built in behavior to request its last-known IP address as part of the end user equipment DHCP discovery phase. In the session based PPP broadband environment, the initial session discovery function known as PPPoE Active Discovery Initiation (PADI) and IP address layer IPCP negotiation typically do not apply the framework for the end user device to request its last known IP address in the configuration portion of the handshake.

Therefore, it is common for end devices using PPP sessions to be assigned a different IP address whenever they establish or start a new session. Whereas in a DHCP environment, end devices typically renew their IP address assignment continuously with the previously used IP address. This is employed to allow more stability in the IP management platforms

The longer an IP address is assigned to a subscriber's equipment, the more likely it is that the physical location of the subscriber will be estimated or identified. This can be achieved in many ways, but principally occurs through direct learning where the users web browsing habits and behavior are learned. For example, such habits and behaviours may include the voluntary disclosure of physical address location as part of online purchasing transaction or other types of transaction. Other involuntary techniques, such as a network topology reverse engineering of the IP address location within a Service Provider IP network, can allow 3^{rd} party entities to generate an estimate of the subscriber's physical location over time.

As an example, in a local advertising system it becomes possible over time to infer where an IP address may be located based on the quantity of marketing creatives that are sent or delivered to each IP addresses. This can be done by selectively and repeatedly targeting the same geographical areas and analyzing the frequency at which one or a plurality of unique identifiers or IP addresses are being served with advertising material.

The result is that, in order to protect the privacy of a subscriber's physical location based on its IP address, an ISP or other Service Provider would normally have to employ an IP Address allocation technique to rotate or move contiguous blocks of IP addresses across its routed network so that an IP address would no longer be assigned to the same physical interne access device.

### SUMMARY OF THE INVENTION

In one aspect, the present disclosure relates to an advertising system for enabling the delivery of one or more advertisements to one or more computers associated with one or more individuals, the system comprising: an advertiser module operable to: receive one or more advertisement identifier and one or more targeting criterion associated with an advertisement; generate a plurality of restricted identifiers in accordance with the targeting criterion; and communicate with a first computer database; an intermediate module operable to: communicate with the advertiser module to receive the one or more advertisement identifiers and the plurality of restricted identifiers; communicate with a second computer database; communicate the plurality of restricted identifiers to at least one service provider; communicate with an association module; and associate the one or more advertisement identifiers with the plurality of non-restricted identifiers; an association module operable by the at least one service provider having a communication interface, said association module being operable to receive the plurality of restricted identifiers; communicate with a third computer database to associate the plurality of restricted identifiers with the plurality of non-restricted identifiers stored in the third computer database; and communicate the indication of the plurality of non-restricted identifiers to the intermediate module; and an IP address allocation module operable by the at least one service provider, said IP address allocation module being operable to: define or access criteria for identifying risk of exposure of the restricted identifiers; monitor the targeting of the one or more individuals to receive the one or more advertisements; and dynamically modify the IP address allocation for the one or more individuals based on meeting the criteria associated with the individual.

In another aspect, the present disclosure relates to a method for configuring one or more advertising campaigns targeted to one or more target locations to be implemented by an advertising system, comprising the following steps: an advertiser communicating with the advertising system to specify target criteria to identify the one or more target locations and to provide one or more advertisers to be directed to the one or more target locations; the advertising system translating or linking the target criteria to one or more physical locations; a campaign manager of the advertising system receiving the target criteria and configuring an advertising campaign.

In another aspect, the present disclosure relates to a method for detecting and managing IP address space allocation of one or more service providers of an advertising system over a communications medium, comprising the following steps: the advertising system isolating IP address statistics of one or more individual members of the advertising system; deriving individual and logical target groups for one or more advertisements; and implementing one or more means to dynamically modify the IP address allocation of the one or more individual members.

In another aspect, the present disclosure relates to an advertising system operable to achieve targeted delivery of advertisements to one or more computers associated with one or more individuals, the system comprising: an advertiser module for accepting an advertisement identifier and a targeting criterion associated with an advertisement, computing a plurality of restricted identifiers satisfying the targeting criterion, and storing the advertisement identifier, the targeting criterion and the plurality of restricted identifiers in a first computer database, wherein the advertisement identifier identifies the advertisement; an intermediate module for receiving the advertisement identifier and the plurality of restricted identifiers from the advertiser module, storing the advertisement identifier and the plurality of restricted identifiers in a second computer database, communicating the plurality of restricted identifiers to at least one service provider, receiving an indication of a plurality of non-restricted identifiers associated with the plurality of restricted identifiers, and associating the advertisement identifier with the plurality of non-restricted identifiers; an association module operated by the at least one service provider having a third communication interface, the association module for receiving the plurality of restricted identifiers, associating the plurality of restricted identifiers with the plurality of non-restricted identifiers stored in a third computer database, and communicating the indication of the plurality of non-restricted identifiers to the intermediate module; and an IP address allocation module operated by the at least one service provider, configured for defining or accessing criteria for identifying exposure of the restricted identifiers being at risk, monitoring the targeting of the individual with advertisements, and dynamically modifying the IP address allocation for the individual based on the criteria being met for the individual.

In another aspect, the present disclosure relates to an advertising method operable to achieve targeted delivery of advertisements to one or more computers associated with one or more individuals, the system comprising: receiving an advertisement campaign and a targeting criterion associated with the advertisement campaign at an advertiser module; computing an advertisement identifier and a plurality of restricted identifiers satisfying the targeting criterion, storing the advertisement identifier, the targeting criterion and the plurality of restricted identifiers in a first computer database and communicating the advertisement identifier and the plurality of restricted identifiers to an intermediate module; receiving the advertisement identifier and the plurality of restricted identifiers at the intermediate module and storing the advertisement identifier and the plurality of restricted identifiers in a second computer database; communicating the plurality of restricted identifiers to an association module; computing at the association module a plurality of non-restricted identifiers, drawn from a third computer database, associated with the plurality of restricted identifiers; communicating an indication of the plurality of non-restricted identifiers associated with the plurality of restricted identifiers to the intermediate module; based on the indication, associating the advertisement identifier to the plurality of non-restricted identifiers; and monitoring the targeting of the individual with advertisements, and dynamically modifying the IP address allocation for the individual based on the criteria being met for the individual by operation of an IP address allocation module.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 illustrates a local advertising system in accordance with the present invention.

FIG. 2 illustrates a distributed advertising system in accordance with the present invention.

FIG. 3 illustrates an address management system in accordance with the present invention.

FIG. 4 illustrates an example of an advertiser configuring an advertising campaign.

FIG. 5 illustrates targeting of an advertising campaign.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a system and method for managing the IP address space allocation of an ISP to reduce the probability that a subscriber's physical location can be discovered based on its IP address. In particular, the present invention is a system and method operable to detect and manage the IP address space allocation of an ISP that is taking part in an advertising system over a communications medium. The system and method of the present invention may incorporate or otherwise be operable to achieve several functions and results, including any of the following: isolating individual member IP address statistics as part of an advertising system; finding individual and logical target groups that achieve a level of demand and popularity among the advertising system; and implementing embodiments of mechanisms to dynamically modify the IP address allocation of one or a plurality of such members within the ISP address allocation system.

The system, method, a computer program of the present invention are operable to provide a privacy-enhanced advertising system. The advertising system enables advertisements to be directed to an individual based on their location information while maintaining the privacy of their location information. The system, method, and computer program provides an ISP address allocation system linked to the advertising system, operable to dynamically modify the IP address allocation for the individual by operation of one or more criteria for determining possible exposure of the location information through repeated targeting of an area or groupings of area.

In the following description, for purposes of explanation, numerous specific details are set forth in order to provide a thorough understanding of the present invention. It will be evident, however, to one skilled in the art that the present invention may be practiced without these specific details. Thus, the invention is not intended to be limited to the specific details, and is to be accorded the widest scope consistent with the principles and features disclosed herein.

One embodiment of the present invention may include a privacy-enhanced advertising system, implemented on the web. In such a system knowledge or information, for example, such as the location of an individual or grouping of IP addresses, may be retained by one organization and not divulged to other parties. The inference of an IP address physical location through repeated targeting of an area or groupings of areas may expose geographical intersections where an IP address is being used by a piece of equipment, for example, such as a PC, router or other internet device. The result may be the exposure of the geographic area associated with a particular individual in a communication medium. This may provide unauthorized access to physical address information or geographic area information associated with an individual.

As an example, advertisers who wish to display advertisements in a web page may have a specific target audience in mind. Often, the target audience may be characterized by a particular geographic location, for example, such as a neighbourhood, a region, an area associated with a particular zip code or postal code, or another location. When choosing advertisements to embed in a web page, web servers may attempt to infer a client's physical location from the known IP address that is used to make a web browser request. However, this may not provide an exact identification of a user's location. This is so, because individual subscribers do not own their IP addresses, but rather are dynamically assigned IP addresses by a service provider. Therefore, IP addresses are only loosely coupled with a physical location or a postal address. Thus, such inferences applied by the prior art can only provide coarse-grained determinations of location of a user, for example, such as the client's city. More specific locations of a user, for example, such as a neighborhood or postal address, cannot be ascertained through such prior art methods or systems.

Network service providers have more accurate information regarding the postal address associated with an IP address (e.g., subscriber's billing address). However, dissemination of personally identifying information about subscribers to third parties is typically restricted due to privacy laws, service agreements or for other reasons. Examples of such restricted identifiers may include names, identification numbers (both government- and privately-issued), telephone numbers, street and postal addresses, e-mail addresses, IP addresses (in some contexts), vehicle registration numbers, driver's license numbers, biometric data, credit information and other identity-related information. However, other identifiers are non-restricted. For example, in the context of a web page request, the subscriber necessarily discloses an IP address as part of the request. This information may comprise a non-restricted identifier for the purposes of fulfilling the web request. Other examples of non-restricted identifiers may include a variety of identifiers, for example, such as telephone numbers, age, gender or race, workplace, and sufficiently coarse-grained location of residence (e.g., city, county, state, etc.).

In some embodiments of the present invention, non-restricted identifiers that are considered sensitive information (e.g., where laws require such information to be anonymized) may be anonymized. This anonymization may be achieved through a variety of means, for example, such as, applying a hash function to generate a hash code that is capable of distinguishing the sensitive information without necessarily revealing it.

One embodiment of the present invention may include a privacy enhanced Internet based advertising system, and in such an embodiment marketing transactions may be undertaken directly between an advertisement network (or “ad network”) and the recipient of commercial advertisements in any form or medium (or “creatives”). Such creatives may take several forms, for example, such as banner ads in an Internet web browser, video and audio based advertising segments, or formatting of web content outside of advertisements. The ad network may rely on a location broker to provide it with a set of matching unique identifiers, based on physical targeting criteria that were provided to the ad network. While there is no direct correlation between the physical targeting criteria managed by a targeting engine, and the physical location of one such unique identifier, it may be understood by the present invention that the identifier falls within the aggregate physical targeting area provided by the ad network.

A targeting engine incorporated in the present invention may include a process (e.g., software, human or otherwise) tasked with calculating location based matches between a set of targeting criteria identifiers, for example, such as those that refer to a geographical location area or sets of geographical areas, and a set of individual locations. In one embodiment of the present invention a targeting engine may be one tasked with locating subscriber IP addresses located within one mile radius of a specific location, for example, such as a retail location or a place of business. A targeting engine would iterate through a set of individual location, and through geographical calculations, to find locations and their unique subscriber identifiers that are within the 1 mile radius targeting criteria. The resulting match set would then be handled by a location broker and stored in a Match Database that is one or more storage areas incorporated in the present invention or otherwise linked to the present invention.

The present invention may offer several benefits over the prior art. As described herein, the prior art may handle subscriber information in a manner whereby a subscriber's physical location is identifiable based solely upon an IP address. One embodiment of the present invention is operable to manage an IP address space allocation of a service provider so as to reduce the probability that a subscriber's physical location can be discovered based on its IP address. This can enhance the privacy of individual subscribers, and provide a privacy enhanced advertising system generally.

The present invention may further offer benefits in the form of functions that other prior art advertising systems are unable to achieve. For example, the present invention may be operable to: isolate individual member IP address statistics as part of an advertising system; find individual and logical target groups so that advertisements can be sent to targeted individuals and groups that will increase the level of demand and popularity achieved by the advertising system; and implement mechanisms to dynamically modify the IP address allocation of one or a plurality of subscribers within an ISP address allocation system. These features offer specific benefits that prior art advertising systems are unable to provide, in particular targeting of advertisements to specific individuals, or groups of individuals meeting target criteria, in a manner that involves data accumulation and review that ensures the targeted individuals or groups truly meet the target criteria.

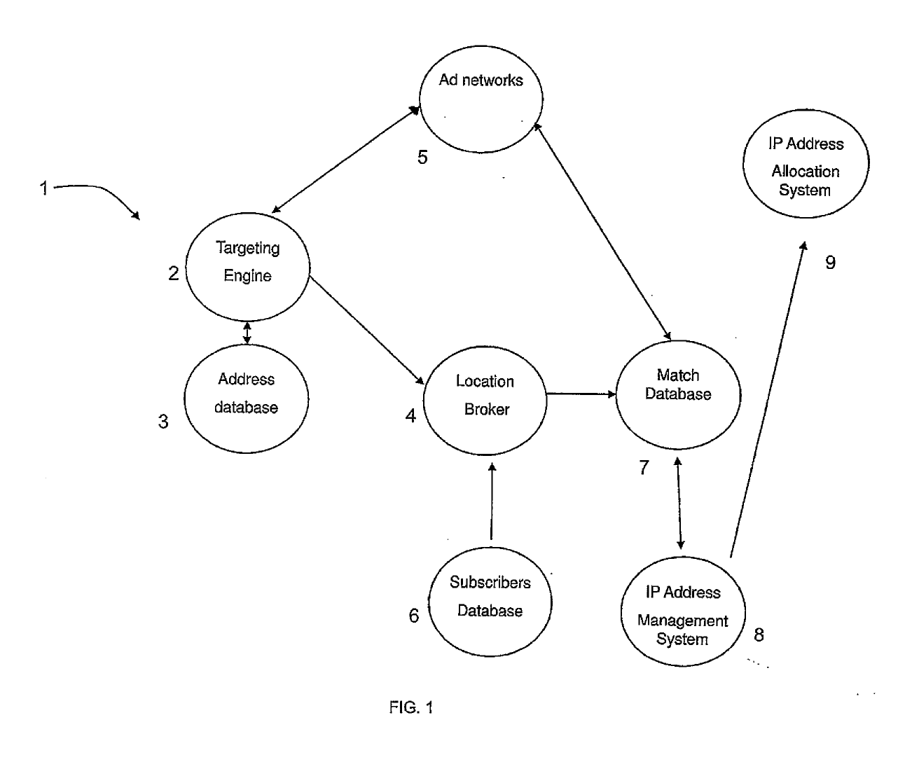

As shown in FIG. 1, the present invention may include a local advertising system 1 comprising a targeting engine 2, a plurality of address databases 3, a plurality of location brokers 4, a plurality of ad networks 5, and a plurality of subscribers, subscriber identifiers, physical location or otherwise unique labels 6 hereinafter “unique identifier”, all connected via a communications medium. In a preferred embodiment of the present invention, the communications medium may be the Internet. However, in other embodiment of the present invention any other type of communications medium may be utilized, for example, such as a local area network, a wide area network, a wireless network, a proprietary network, or the like.

One embodiment of the present invention may comprise one or more special purpose computers or servers, and/or one or more general-purpose computers or servers. Each of the one or more computers and/or servers, whether special purpose or general-purpose in nature, may include any of the following: one or more processors; memories; storage devices; input/output devices; network interfaces; or any other components. Herein the terms ‘computer’ and ‘server’ may be interchangeable in accordance with the above description.

Embodiments of the present invention may be implemented as computer software in the form of computer readable code executed in memory by processors on one or more of the computers or servers contemplated above. Moreover, although the present invention is illustrated in FIG. 1 as incorporating separate components, it should be understood that various components could be combined into a single computer or server, or implemented across multiple computers or servers all connected via a communications medium (such as the Internet) without departing from the scope of the present invention.

The targeting engine 2 of the present invention may provide a set of location based criteria capability to an entity, for example, such as an ad network 5, that is operable to identify a set of unique identifiers that fall within a range of physical locations to effectively focus a local advertising campaign. In a preferred embodiment of the present invention, the targeting engine 2 provides an ad network 5 with a set of readily identifiable locality criteria such as physical or mailing address, a distance radius from such an address, other generally accepted locality identifier such as, but not limited to, a mailing ZIP code with or without extension, a government district, telephone dialling area code or (hereinafter “targeting criterion”). The targeting engine 2 provides a method for ad networks 5 to correlate with external data by using a common link such as, but not limited to, the subscriber mailing address. To do so, the targeting engine 2 can rely on a common data store containing the correlation and common link information such as, but not limited to, ZIP codes, addresses, phone numbers, district, to the mapped physical location expressed in types such as, but not limited to, geographical coordinates containing latitude, longitude and altitude.

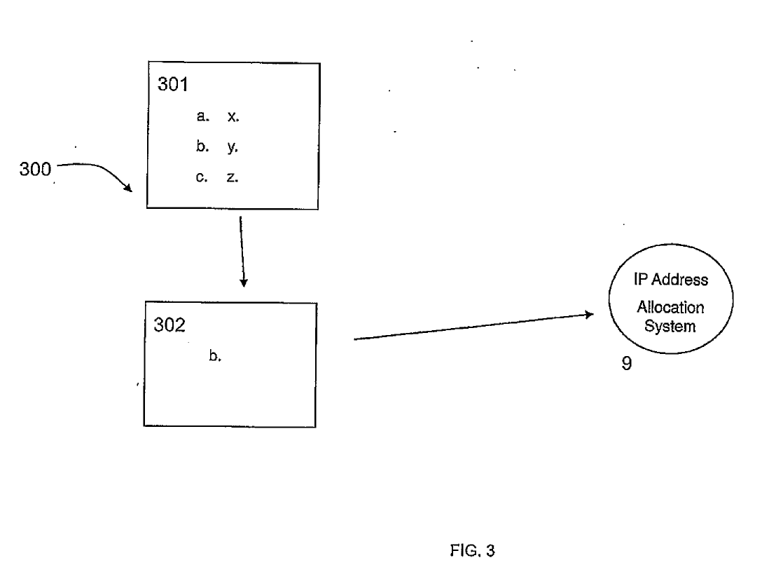

The IP address management system 8 may be of several types and may incorporate a variety of functions. As an example, as shown in FIG. 3, in one embodiment of the present invention 300 of the IP address management system may incorporate a table 301 that represents the list of unique identifiers, for example, such as a to c, and their individual match counters, for example, such as x to z. A popularity service 302 uses one or a plurality of algorithms to monitor parameters such as but not limited to the rate and frequency at which a unique identifier a to c counter x to z is kept. At one, or plurality of, intervals, the popularity service 302 selects a unique identifier present in the table 301 based on the threshold reached by its counter and selects it for address modification. In this embodiment 300, the unique identifier b was selected by the popularity service 302.

When the popularity service 302 of the embodiment 300 IP address management stores a, or a plurality of, subscriber unique identifier for modification, it forwards the list of such unique identifier information to an IP address allocation system. The IP address allocation system can be, but is not limited to, a Service Provider server running a standards based network address allocation system. Known embodiments of IF address allocation system can be, but are not limited to, DHCP, RADIUS, DIAMETER and static address server infrastructures in which a Service Provider manages the list of IP address allocation it wishes to grant to subscribers and their devices that are using its network and services.

The popularity service 302 forwards one or a plurality of identifiers selected for address modification to the IP address allocation system. The IP address allocation system of the Service Provider identifies the IP address allocation assigned to the unique identifier b and assigns the unique identifier b, a, or a plurality of, new IP address allocation that is dissimilar from the one found in the match database for the unique identifier. The IP address allocation system will then apply and assign the new IP address allocation to the subscriber unique identifier b so that it can operate under a different IP address while accessing the ISP network resources.

The popularity service 302 may include an administrative utility that enable an administrative user of the popularity service 302 to establish one or more settings that determine for a particular service provider (whether based on service provider requirements, local privacy laws, or otherwise) the parameters for selecting a unique identifier for address modification. For example, a graphical dialog may allow an administrative user to select a percentile or raw usage threshold that would trigger address modification. A graphical dialog may also be provided for assigning a dissimilar contiguous range or pool of IP addresses from which to assign to subscriber selected for address modification. A set of minimal usage thresholds that each unique identifier must reach before IP address modification is enacted, and the type of CPE device for which the selection is to be enabled, such as fixed broadband, fixed wireless, or mobile wireless devices may also be specified.

The elements of the present invention, such as those shown in FIG. 1, may be incorporated into, or otherwise linked with, advertising systems generally. In such systems all or some of the elements may be incorporated in the advertising system, and/or all or some of the elements may be linked to the advertising system or otherwise accessible to communicate with the advertising system. A skilled reader will recognize the variety of configurations of the present invention in the context of various advertising systems.

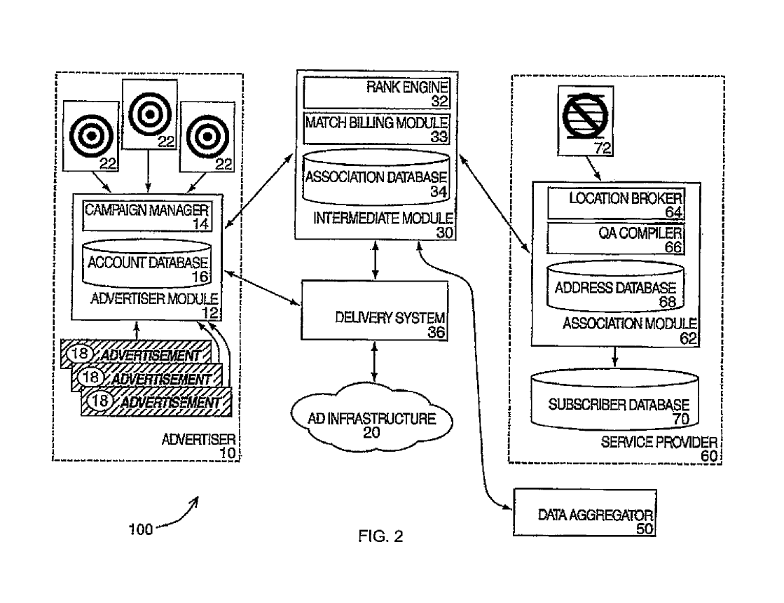

As shown in FIG. 2, an embodiment of the present invention may include a distributed advertising system 100 that comprises a query answer (QA) or intermediate module 30 and a delivery system 36 for advertisements in communication with each other over a network, such as the Internet. Delivery system 36 is in communication with advertising infrastructure 20. In some embodiments of the present invention, delivery system 36 may be part of advertising infrastructure 20. Intermediate module 30 may also be in communication with advertiser 10 and service provider 60.

In some embodiments of the present invention, intermediate module 30 may communicate with a plurality of advertisers 10 and service providers 60. In some embodiments of the present invention, intermediate module 30 may also communicate with at least one data aggregator 50. In still other embodiments of the present invention, the communications medium may be a network other than the Internet including, for example, a local area network, a wide area network, a wireless network, a proprietary network, etc. In yet other embodiments of the present invention, delivery system 36 may be integrated into intermediate module 30.

Advertiser 10 may be a party promoting goods and/or services, preferably via the Internet. Advertiser 10 is preferably provided access to an advertiser module 12, which has an account database 16 and a campaign manager 14. The campaign manager may be operable to accept one or more advertisements 18 and to target criteria 22 associated with each of the advertisements 18. The campaign manager 14 may also be operable to accept other data, such as custom demographic data. For example, in one application of an embodiment of the present invention, a neighborhood restaurant may wish to target homes within a certain radius of the restaurant. As another example of an application of an embodiment of the present invention, a retail store may have a list of postal addresses obtained through a direct relationship or its own records, which it may already use for direct marketing purposes.

Advertiser 10 may communicate with, or incorporate, elements of the present invention that include one or more ad networks and/or one or more targeting engines. Through this communication the advertiser 10 may operate to determine a target area and unique identifiers that fall within the target area, as discussed herein. Through this communication a set of readily identifiable locality criteria may be identified relating to the target area and subscribers of the advertising system that are located within the target area, as discussed herein. Additionally, one or more address databases may be utilized in the course of this communication, as discussed herein. The advertiser 10 may be operable to utilize elements of the present invention to configure advertising campaigns, and in particular advertising campaigns targeted to specific subscribers meeting particular targeting criteria.

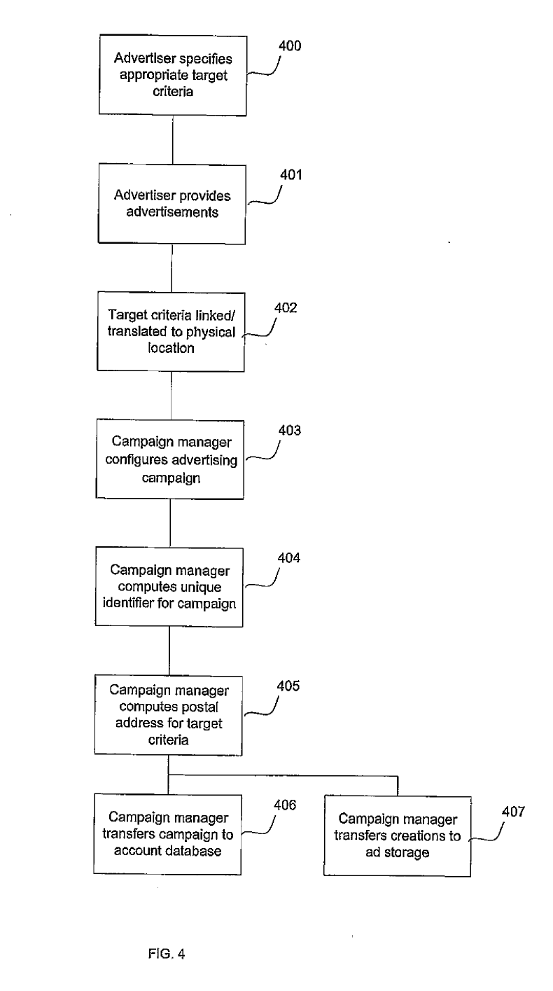

As shown in FIG. 4, in one embodiment of the present invention, an advertiser may configure advertising campaigns by specifying 400 appropriate target criteria and providing 401 associated advertisements. Targeting criteria may be data that can be linked to or translated into a physical location or plurality of physical locations, preferably in the form of postal addresses. Such data may include postal addresses (such as a home, apartment, office building, or any other physical geographical location), postal or ZIP codes and their enhancements (e.g., ZIP+4), existing neighborhood trading areas (NTAs), demographic market areas (DMAs), latitude/longitude coordinates identifying a geographic location, coordinates (e.g., latitude/longitude or a postal address) and inner and outer radii defining a geographical area in a roughly circular band centered about the coordinates, coordinates (e.g., latitude/longitude or postal addresses) defining a polygon-shaped area, GPS data, government-issued identification numbers (e.g., driver's license number, social security number, etc.), privately-issued identification numbers (e.g., rewards program membership number), demographic data (e.g., median age in a neighborhood), fuel prices data, weather data, real estate data, census data (e.g., median income for a neighborhood), credit scores (e.g., neighborhood level), electoral districts, school districts, etc. In alternative embodiments, advertiser module may be integrated into intermediate module.

Linking or translation 402 of targeting criteria to physical locations may be direct, as in the case of postal addresses, or may require intermediate data from another database or third party to determine its association with a postal address, as in the case of driver's license numbers. Accordingly, targeting data may be any data that is capable of being mapped or translated to one or more physical addresses. In some cases, the mapping or translation may occur in real-time. For example, in one application of an embodiment of the present invention utilized for fuel prices data, targeting criteria may specify that postal addresses in neighborhoods where the average price of gasoline is above a certain threshold should be targeted. If fuel prices data is available in real-time, the targeted neighborhoods may change in real-time to reflect changes in fuel prices.

As shown in FIG. 2, service provider 60 may operate a communication service (e.g., Internet access provider) and, accordingly, has accurate and real-time knowledge of the current mailing or billing address (which preferably correspond to postal addresses) and current IP address of each subscriber to the communications service it operates. In many cases, service provider 60 is mandated by law to maintain accurate and real-time address information for the provision of emergency services (e.g., enhanced 911 service). Service provider 60 preferably has a subscriber database 70. Subscriber database 70 may contain detailed subscriber information, for example, such as name, billing address and other data known about the subscriber. Some of the subscriber data may be private.

Location broker 64 may take data inputs from service provider 60 and data aggregator 50. The location broker 64 may further communicate with, or be otherwise linked to, other elements of the present invention in a manner discussed herein. Preferably, service provider 60 and data aggregator 50 provide IP address to postal address mappings to location broker 64. Location broker 64 may validate postal addresses for compliance with chosen standards, such as postal standards, and transfer the IP address to postal address mappings into address database 68, preferably in a background operation. Accordingly, service provider 60 and data aggregator 50 may provide data in a bulk transfer, preferably at least daily in order to ensure the accuracy of the data. Alternatively, data may be provided on a continuous or even real-time basis, depending on the needs of service provider 60 or data aggregator 50.

As shown in FIG. 4, the campaign manager may take data inputs (e.g., target criteria, advertisement files, custom demographic data) from at least one advertiser and at least one advertising network to configure advertising campaigns 403. For each advertising campaign, the campaign manager may compute a unique identifier 404, which will be used by other modules (e.g., intermediate module) to reference the campaign without directly identifying the advertiser or the specifics of the advertising campaign. The campaign manager may further compute postal addresses satisfying the target criteria 405. For example, if the target criteria are a center address and inner and outer radii of a target zone, campaign manager computes the postal addresses falling between the inner and outer boundaries specified by the radii, when centered around the center address. The campaign manager transfers the configured advertising campaign information 406 to an account database. Likewise, the campaign manager transfers creatives to an ad storage repository of a delivery system. An account database may also receive periodic data inputs from tracking/billing module of the delivery system.

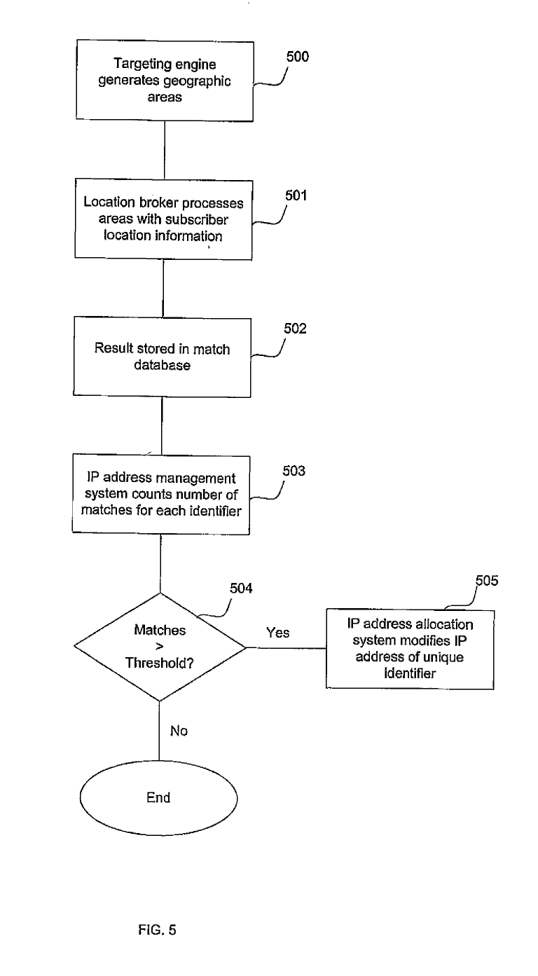

As shown in FIG. 5, in one embodiment of the present invention, the targeting engine may gather one or a plurality of targeting criterion and generate one or a plurality of logical or geographical contiguous areas 500 within which a subscriber physical address information contained in one or a plurality of subscriber database must be physically located in order to be included in the resulting match database.

The location broker may receive the single or plurality of computed logical contiguous areas from the targeting engine. The location broker may also receive a set of common location identifiers from a subscriber database which contains one, or a plurality of, potentially addressable customer location information.

The location broker may process each subscriber location information 501 from the subscriber database against the matching criteria of the targeting engine. The resulting set of subscriber information contained in the subscriber database matching the location criteria supplied by the ad network 5 to the targeting engine may then be stored in a match database.

The match database may operate a repository for a single or plurality of separate targeting criteria matches containing a single, or a plurality of, subscriber list(s) for which a location broker has previously identified as being located within a geographical area targeted by an ad network.

The IP address management system may analyze all matching sets in the match database for a single, or plurality of, ad network(s). The IP address management system may include a counter function, hereinafter the counter, to tabulate the number of instances for each unique identifier found to match any targeting criteria 503.

The IP address management system may track each counter and calculate that one, or a plurality of unique identifiers in the matching database is matching targeting criteria from an ad network using parameters such as but not limited to, time or frequency that is exceeding a threshold set by one, or a plurality of, algorithm 504. The IP address management system may store the selected unique identifier for modification by an IP address allocation system of the ISP 505.

In the application of one embodiment of the present invention, the list of such unique identifier information to be provided to the IP address allocation system may use software integration infrastructure with the IP management system of a serialized data container over a data-interchange format such as JSON (JavaScrit Object Notation) or XML-RPC or other. The data-interchange may contain a unique transaction record identifier, a transaction timestamp, a CPE unique identifier, the current CPE IP address, and a list of one or many threshold parameters that enacted the IP modification request. The list may be sent to the IP address allocation system 9 by way of a data-interchange format using an existing or extended application capability or standardized signalling interfaces, such as a DIAMETER, IMS (IP Multimedia Subsystem), DHCP lease query. The IP address allocation system receives the list, and it may be provided to the network access device component of the IP address allocation system. The IP address allocation system implements the list by verifying the CPE unique identifier to its list of currently managed devices, the current IP address assigned to the device and the validity and availability of a new IP address allocation. Depending on the IP address allocation system, such a process may require modification to the existing IP address assignment workflow, or may be short-circuited by leveraging the existing internal system capabilities. The results of the IP address assignment modification request may be communicated back to the popularity service or into the legacy IP address allocation system log facilities.

In order to enable a subscriber IP allocation change via an IP address management system such as a DHCP server, RADIUS server, IP Address Management System (IPAM) or otherwise, software integration may be required to signal the proper identifiers. In the embodiment described above, the ISP may be provided with hardware or software components that are installed within their computer network. These software or hardware device may participate in a Privacy enhanced advertising platform in an existing role or capacity, such as a matching engine with which a popularity service 302 would provide a list of existing IP address allocations which require a change in IP address assignment. The list may be further processed to verify the validity of the list and authenticity of the of the popularity service 302. Such a system would then be integrated with the ISP IP address Management System in a way that permits it to alter the IP address allocation scheme the ISP may have programmed or designed within the software.

As part of its workflow, the IP Address Management System may report back any internal transaction results, whether successful or not to the popularity service 302, which would reset a popularity counter assigned to the subscriber.

In an embodiment of the present invention, an online advertising campaign may be set to target advertising creative to one or a plurality of households in a specific area of a major neighbourhood. This online advertising campaign would display a set of rotating creatives to one or a plurality of household for which the advertiser may have obtained targeting data identifiers allowing it to have a presumption of physical location accuracy based on the CPE IP address located in the household.

Over the length of time during which the advertising campaign is active, one or a multitude of CPE devices or computers located within a single or plurality of households may be subject to a quantity of advertising creative larger than the average distribution of marketing material. This could be the result of a higher than average online internet activity on the part of the household leading to more online ads being served to the end devices.

In this embodiment of the present invention, the location identifiers may be supplied to the advertiser via a privacy enhanced system where the service provider has enabled location based identifiers for the advertiser.

While the campaign is ongoing, the privacy enhanced system would keep a running counter of the number of times each household has been targeted with online advertising via its data interchange platform with the advertiser. The privacy enhanced advertising system would then rank in descending order, the number of impressions served to each household and elect to have the top 5% of household CPEs change their IP address.

The privacy enhanced system would then tabulate the list of CPE IP addresses for which the IP address needs to be modified and transfer to the Service Provider address management system a list containing the IP addresses requiring an IP change, and the time at which this list was generated.

The service provider address management system may have purpose built software integration with the Privacy enhanced advertising platform, which allows it to re-assign a CPE to a new IP address within another network group that is dissimilar to the current one in use.

The foregoing detailed description should be regarded as illustrative rather than limiting. It should be appreciated by those skilled in the art, in light of the present disclosure, that many changes can be made in the specific embodiments which are disclosed and still obtain a like or similar results. It will further be appreciated by those skilled in the art that other variations of the embodiments described herein may also be practiced without departing from the scope of the invention. Other modifications are therefore possible.

I claim:

1. An advertising system for enabling the delivery of one or more advertisements to one or more computers associated with one or more individuals, the system comprising:
(a) an advertiser module operable to: receive one or more advertisement identifier and one or more targeting criterion associated with an advertisement; generate a plurality of restricted identifiers in accordance with the targeting criterion; and communicate with a first computer database;
(b) an intermediate module operable to: communicate with the advertiser module to receive the one or more advertisement identifiers and the plurality of restricted identifiers; communicate with a second computer database; communicate the plurality of restricted identifiers to at least one service provider; communicate with an association module; and associate the one or more advertisement identifiers with the plurality of non-restricted identifiers;
(c) an association module operable by the at least one service provider having a communication interface, said association module being operable to receive the plurality of restricted identifiers; communicate with a third computer database to associate the plurality of restricted identifiers with the plurality of non-restricted identifiers stored in the third computer database; and communicate the indication of the plurality of non-restricted identifiers to the intermediate module; and
(d) an IP address allocation module operable by the at least one service provider, said IP address allocation module being operable to: define or access criteria for identifying risk of exposure of the restricted identifiers; monitor the targeting of the one or more individuals to receive the one or more advertisements; and dynamically modify the IP address allocation for the one or more individuals based on meeting the criteria associated with the individual.

2. The advertising system of claim 1, wherein the one or more advertisement identifiers identify each of the one or more advertisements.

3. The advertising system of claim 1, wherein the advertiser module communicates with the first database to store in the first database the advertisement identifier, the targeting criterion and the plurality of restricted identifiers.

4. The advertisement system of claim 1, wherein the intermediate module store communicates with the second database to store in the second database the advertisement identifier and the plurality of restricted identifiers.

5. The advertisement system of claim 1, wherein the IP address allocation module is operable to manage the IP address space allocation of the at least one service provider, and thereby reduce the probability that the physical location of the one or more individuals is discoverable based on the IP address.

6. The advertisement system of claim 1, wherein the advertisement system is a privacy-enhanced advertising system implemented on the web.

7. The advertisement system of claim 1, wherein the one or more advertisements are creatives including any of the following: banner advertisements in an Internet web browser; video based advertising segments; audio based advertising segments; or formatting of web content outside of advertisements.

8. The advertisement system of claim 1, wherein any of the advertiser module, the intermediate module, the association module, and the IP address allocation module are combined into a single module, computer or server.

9. The advertisement system of claim 1, wherein the advertisement system communicates with a plurality of IP address databases.

10. A method for detecting and managing IP address space allocation of one or more service providers of an advertising system over a communications medium, comprising the following steps:
(a) the advertising system isolating IP address statistics of one or more individual members of the advertising system;
(b) deriving individual and logical target groups for one or more advertisements; and
(c) implementing one or more means to dynamically modify the IP address allocation of the one or more individual members.

11. The method of claim 10, further comprising the step of repeatedly targeting an area or grouping of areas to expose one or more geographical intersects to inferring an IP address physical location.

12. The method of claim 11, further comprising the step of identifying the one or more geographical intersects as occurring when the IP address of the one or more individual members is used by a piece of equipment, including a computer, a router, or an Internet device.

13. The method of claim 10, further comprising the step of anonymizing one or more non-restricted identifiers that represent sensitive information.

14. The method of claim 13, further comprising the step of applying a hash function to generate a hash code capable of distinguishing the sensitive information without revealing said sensitive information.

15. The method of claim 10, further comprising the step of utilizing the communications medium that includes any of the following: a local area network, a wide area network, a wireless network, or a proprietary network.

16. The method of claim 10, further comprising the step of implementing the method as computer software in the form of computer readable code executed in memory by one or more processors of one or more computers or one or more servers of the advertising system.

17. A method for configuring one or more advertising campaigns targeted to one or more target locations to be implemented by an advertising system, comprising the following steps:
(a) an advertiser communicating with the advertising system to specify target criteria to identify the one or more target locations and to provide one or more advertisers to be directed to the one or more target locations;
(b) the advertising system translating or linking the target criteria to one or more physical locations;
(c) a campaign manager of the advertising system receiving the target criteria and configuring an advertising campaign.

18. The method of claim 17, further comprising the following steps:
(a) the campaign manager computing one or more unique identifiers for the advertising campaign;
(b) the campaign manager computing one or more postal addresses in accordance with the target criteria;
(c) the campaign manager transferring: the advertising campaign to an account database; and one or more creations to one or more storage areas.

19. The method of claim 18, further comprising the steps of:
(a) the advertising system communicating the target criteria to a targeting engine incorporated in the advertising system or linked to the advertising system, and the targeting engine generating one or more geographic areas in accordance with the target criteria;
(b) a location broker that is incorporated in the advertising system or linked to the advertising system communicating with the targeting engine and processing one or more geographic areas with location information of individual members of the advertising system;
(c) the advertising system storing results generated by the location broker and the targeting engine in one or more storage areas;
(d) an IP address management system that is incorporated in the advertising system or linked to the advertising system counting a number of matches for each unique identifier;
(e) the advertising system determining if the number of matches exceeds a threshold and an IP address allocation system modifying an IP address of a unique identifier if the number of matches exceeds the threshold.
